(19) United States
(12) Patent Application Publication
(10) Pub. No.: US 2004/0070265 A1
(43) Pub. Date: Apr. 15, 2004

(54) Vehicle slip stop device

(75) Inventors: Moriharu Sakai, Kariya (JP); Takashi Watanabe, Kariya (JP); Shoichi Masaki, Kariya (JP)

Correspondence Address: BURNS DOANE SWECKER & MATHIS L L P, POST OFFICE BOX 1404, ALEXANDRIA, VA, 22313-1404, US

(73) Assignee: ADVICS CO. LTD.

(21) Appl. No.: 10/679,360

(22) Filed: Oct. 7, 2003

(30) Foreign Application Priority Data
Oct. 8, 2002 (JP) 2002-295075

(51) Int. Cl. B60T 17/00

(52) U.S. Cl. 303/1; 291/3

(57) ABSTRACT

A slip stop device for a vehicle is proposed in which slip stop material can be easily resupplied and it can be reliably scattered near the ground contact portions of tires. A cartridge for storing the slip stop material includes a tubular container having its opening at its top end closed by a film. By inserting a pipe connecting to piping for supplying positive pressure and a pipe connected to a piping for discharging the slip stop material into the cartridge through the film, the slip stop material can be easily resupplied without spilling out. Also, it is possible to reliably scatter the slip stop material stored in the cartridge near the ground contact portions of tires.

### BACKGROUND OF THE INVENTION

This invention relates to a device for preventing slippage of vehicle wheels at start or while the vehicle is traveling.

Roads in cold regions are often frozen and/or covered with snow. Vehicles tend to slip on such roads. Thus, vehicle owners in cold regions have to change their summer tires to snow tires before winter season. Old snow tires typically had slip-stop studs on their treads. But since studs planted in tires scrape road surfaces and produce a lot of concrete or asphalt dust, the use of studded tires have been banned in some countries. As an alternative to studded tires, what is known as “studless” snow tires are now being used. Or as a more economical alternative, tire chains are used.

But it is extremely troublesome to put tire chains on and remove them. Also, tire chains make driving uncomfortable. Thus, in the winter season, most of vehicles in cold regions as well as vehicles that frequently visit cold regions are equipped with studless snow tires. But studless snow tires have one problem in that they polish and mirror-finish frozen road surfaces into practical skating rinks. This naturally promotes accidents such as collisions due to slippage.

To increase friction between vehicle tires and such mirror-finished frozen roads, slip stop devices are proposed (in JP patent publications 4-38204, 7-309101 and 8-25905) in which a slip stop materials such as sand or ice particles is scattered near the tire contact portion. In these slip stop devices, by storing a solid such as sand or a liquid which is a raw material for ice particles in a container for a scattering material, and providing a positive or negative pressure into the container for the scattering material, the slip stop material stored in the container is discharged by blow-out or suction.

In the JP utility model publication 3015393, a slip stop device is proposed in which the container for storing sand is a cartridge type and the sand in the container is dropped near the tire contact portions when the brakes are stepped on.

In each of the former slip stop devices, since slip stop material is scattered by providing positive or negative pressure, the slip stop material in the container can be reliably discharged and scattered on the road surface. But it is troublesome to resupply the slip stop material, and also the slip stop material tends to spill out during resupply.

On the other hand, in the latter slip stop device, the slip stop material can be easily resupplied by changing cartridges. But since the slip stop material is naturally dropped through the bottom of the scattering material container, sometimes the slip stop material is not scattered sufficiently.

An object of this invention is to provide a vehicle slip stop device in which slip stop material can be easily resupplied, and it can be reliably scattered near the tire contact portion.

### SUMMARY OF THE INVENTION

According to this invention, there is provided a vehicle slip stop device mounted on a vehicle for scattering a slip stop material near contact portion of tires on the ground, characterized in that the slip stop material is stored in a cartridge having at least one opening which is closed by a film, and a pipe for discharging the slip stop material stored in the container under a positive or negative pressure is inserted into the cartridge through the film.

By storing a slip stop material in a cartridge having its opening closed by a film and inserting a pipe for discharging the slip stop material under a positive or negative pressure through the film of the cartridge, it is possible to easily replenish the slip stop material without spilling, and also it is possible to reliably scatter the slip stop material stored in the cartridge near the contact portions of tires on the ground.

In the case of a type in which the stored slip stop material is discharged under positive pressure, the pipe may comprise a pipe for supplying the positive pressure, and a pipe for discharging the slip stop material. In this case, two openings closed by films may be provided, and the pipe for supplying positive pressure and the pipe for discharging the slip stop material may be inserted through the films covering the separate openings.

### BRIEF DESCRIPTION OF THE DRAWINGS

Other features and objects of the present invention will become apparent from the following description made with reference to the accompanying drawings, in which:

FIG. 1 is a schematic view showing an embodiment of the slip stop device;

FIG. 2 is a vertical sectional view showing the cartridge; and

FIG. 3 is a schematic view of a vehicle on which is mounted the slip stop device of FIG. 1.

### DETAILED DESCRIPTION OF THE PREFERRED EMBODIMENT

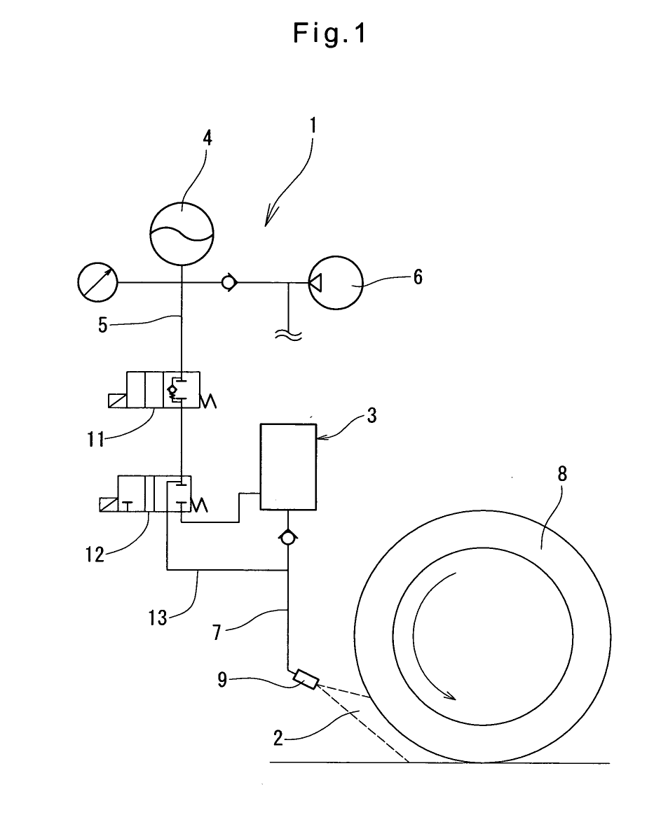

The embodiment of FIGS. 1-3 is now described. As shown in FIG. 1, the slip stop device of the embodiment comprises cartridges 3 for storing a slip stop material 2, a pump 6 connected to the cartridges 3 through lines 5, accumulators 4 provided in the lines 5 for accumulating positive pressure produced by the pump 4, and nozzles 9 connected to the respective cartridges 3 through lines 7 for scattering the slip stop material 2 supplied from the cartridges 3 in a space between the tire and the road surface. The slip stop material 2 may be sand or plant seeds.

In each line 5, two solenoid valves 11, 12 controlled by a controller 10 are provided. The controller 10 monitors the pressure in each accumulator 4 and controls the pump 6 to keep constant the pressure in the accumulators 4. A bypass 13 extends between each solenoid valve 12 and the nozzle 9 so that only pressurized gas can be supplied to the nozzle. If the gas is smoothly blown out of the nozzle, one can confirm that the nozzle is not clogged.

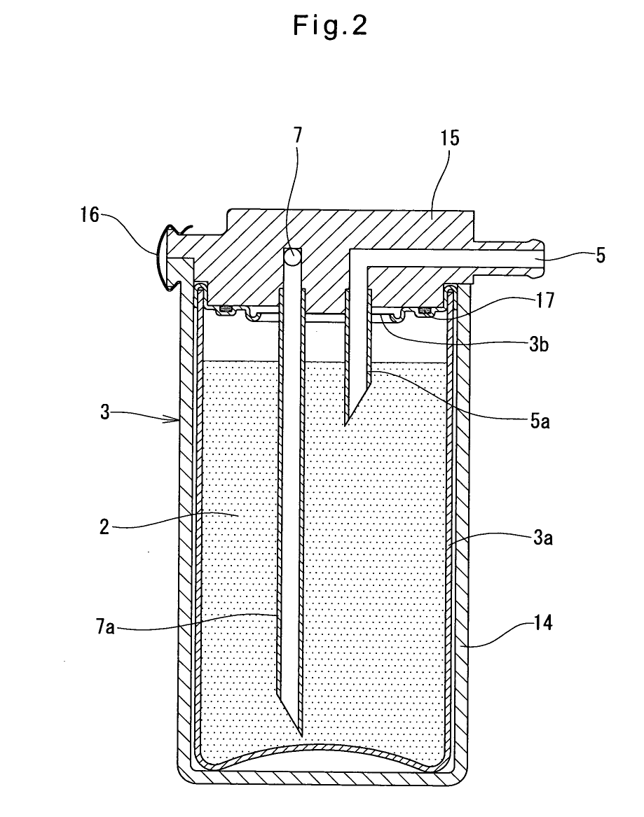

FIG. 2 shows one of the cartridges 3. It comprises a tubular container 3a having a top opening, and a film 3b of metallic foil covering the top opening of the container 3a, and is inserted in a sheath 14 fixed to the vehicle body. A cover 15 is snapped at 16 on the top end of the sheath 14. A pipe 5a connected to a line 5 extending to the pump 6 and a pipe 7a connected to a line 7 extending to a nozzle 9 are mounted to the cover 15.

The pipes 5a and 7a have their tips sharpened and are stuck through the film 3b into the cartridge 3. The bottom end of the pipe 5a, through which positive pressure is supplied, is located at an upper portion of the cartridge 3, while the bottom end of the pipe 7a, through which the slip stop material 2 in the cartridge 3 is discharged, is located near the bottom of the cartridge 3. An annular packing 17 is disposed between the cover 15 and the outer periphery of the film 3b to prevent the slip stop material 2 from leaking out or into between the sheath 14 and the tubular container 3a.

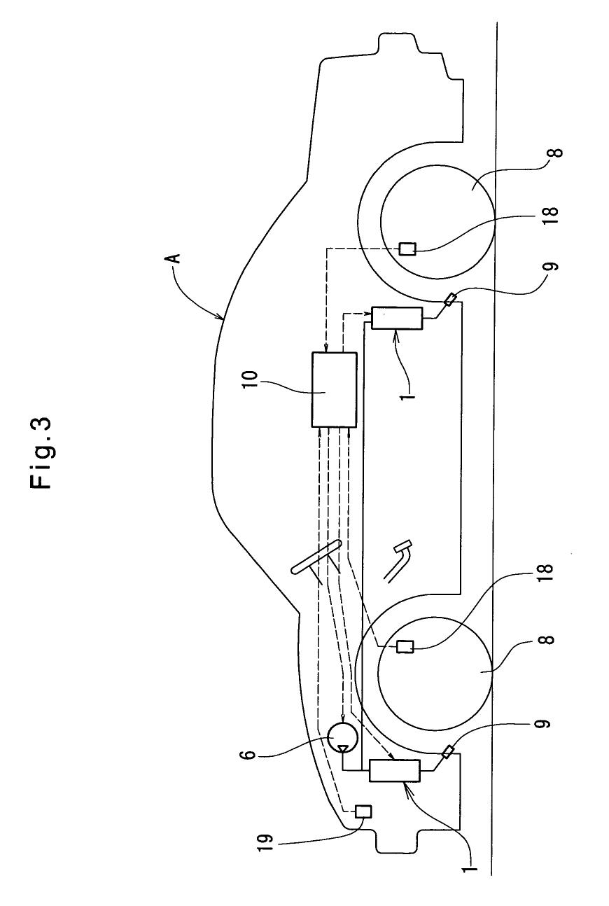

FIG. 3 shows how the slip stop device of the present invention is mounted on a vehicle A. The controller 10 calculates the degree of slippage S of each wheel based on information from wheel speed sensors 18 for the respective wheels 8, and a vehicle speed sensor 19. If the degree of slippage S of any wheel or wheels exceeds a predetermined threshold ST, the controller 10 opens the respective solenoid valves 11, 12 to scatter the slip stop material through the respective nozzle or nozzles 9 on the road surface near the respective tire or tires. At start of the vehicle, only the driving wheels can slip. Thus, during acceleration, the slip stop material 2 may be scattered on the road surface only right in front of the tires of the driving wheels for which the degree of slippage has exceeded a threshold.

In this embodiment, a single opening of the tubular container of each cartridge is closed with a film of metallic foil. But instead, the tubular container may have two openings closed by separate films, and the pipes 5a and 7a may be stuck through the respective films into the cartridge 3. The cartridges are not limited to cylindrical cartridges, and the film covering the opening of each cartridge is not limited to a metallic foil, but may be of a resin, rubber, or paper.

In the embodiment, the slip stop material in each cartridge is discharged through the pipe 7a and line 7 by supplying positive pressure out of the cartridge. But it may be discharged by negative pressure. In an alternative arrangement, the slip stop material in the cartridges is sucked up with a suction pump. This arrangement is preferable if the slip stop material is a liquid.

With this arrangement, the slip stop material can be supplied without spilling it, and the slip stop material in the cartridges can be reliably scattered on a road surface right in front of the tires.

What is claimed is:

1. A vehicle slip stop device mounted on a vehicle for scattering a slip stop material near contact portion of tires on the ground, characterized in that the slip stop material is stored in a cartridge having at least one opening which is closed by a film, and a pipe for discharging the slip stop material stored in the container under a positive or negative pressure is inserted into said cartridge through said film.

2. The vehicle slip stop device as claimed in claim 1 wherein the slip stop material stored in said cartridge is discharged under a positive pressure, and said pipe comprises a pipe for supplying the positive pressure and a pipe for discharging said slip stop material.
